(19) United States
(12) Patent Application Publication
(10) Pub. No.: US 2024/0329071 A1
(43) Pub. Date: Oct. 3, 2024

(54) TRANSFER DEVICE FOR TRANSFERRING SAMPLE CONTAINERS IN A SAMPLE HANDLING SYSTEM

(71) Applicant: Roche Diagnostics Operations, Inc., Indianapolis, IN (US)

(72) Inventors: Avinash Addihalli Narayana, Kornwestheim (DE); Tobias Huber, Ludwigsburg (DE)

(73) Assignee: Roche Diagnostics Operations, Inc., Indianapolis, IN (US)

(21) Appl. No.: 18/579,561

(22) PCT Filed: Jul. 15, 2022
(86) PCT No.: PCT/EP2022/069822

§ 371 Date: Jan. 16, 2024

(30) Foreign Application Priority Data
Jul. 16, 2021 (EP) 21186079.6

(51) Int. Cl. G01N 35/00; B25J 15/02

(52) U.S. Cl. CPC G01N 35/0099; B25J 15/0246

(57) ABSTRACT

A transfer device (110) for transferring sample containers in a sample handling system (112) is disclosed. The transfer device (110) comprises:
at least one transport device (114) comprising an array (116) of electromagnetic actuators (118), specifically electromagnetic actuators (118) comprising electromagnetic coils (120);
at least one moving unit (122) comprising at least one permanent magnet (124), wherein the moving unit (122) is movable in at least one movement plane (126), specifically in at least one movement plane (126) of the moving unit (122) defined by at least two moving directions (128), through the array (116) by magnetic interaction of the permanent magnet (124) with the electromagnetic actuators (118); and
at least one gripper unit (130) for positioning at least one of the sample containers, wherein the gripper unit (130) is movable in at least one gripping direction (132) essentially perpendicular to the movement plane (126), wherein the gripping unit (130) is attached to the moving unit (122).

Further disclosed is a sample handling system (112) for handling a plurality of sample containers and a method for transferring sample containers in a sample handling system (112).

### TECHNICAL FIELD

The invention relates to a transfer device for transferring sample containers in a sample handling system, to a sample handling system for handling a plurality of sample containers comprising said transfer device and to a method for transferring sample containers in a sample handling system. The devices and method of the present invention, as an example, may be used in the field of medical or chemical laboratories in which typically a plurality of samples have to be handled. The samples may contain liquid samples, for example biological samples, such as blood, blood plasma, blood serum, urine, saliva or other types of bodily fluids, and/or chemical samples, such as reagents, reactants or solvents. As an example, the sample handling system may be used for processing the plurality of samples, such as for performing an analytical and/or a pre-analytical step with the samples to be handled. However, other types of applications comprising the handling of samples are also feasible.

### BACKGROUND Art

In the field of medical or chemical laboratories, generally, a plurality of samples, for example liquid samples, have to be handled automatically. In these laboratories, the plurality of samples are usually combined in containers and may be transported through the laboratory from one location to another, for example from a pre-analytical module to an analytical module or the like. The handling of sample containers is usually performed automatically, for example when transferring samples in between transport modules and/or from a transport module to the pre-analytical module or to the analytical module.

As an example for automated product handling, US 2017/0225911 A1 describes an arrangement for transferring and/or grouping products comprising at least one mover which has at least one permanent magnet which is connected to the mover. The permanent magnet interacts with at least one coil plane of a drive surface for the in particular contactless driving of the mover. The mover is arranged displaceable and/or rotatable in at least two degrees of freedom on the drive surface. The arrangement furthermore comprises at least one conveying system which conveys products. The mover picks up or deposits at least one product by means of a movement of the mover with at least one vertical component.

U.S. Pat. No. 10,669,049 B2 discloses a device for filling a receptacle comprising at least one filling station for filling at least one receptacle and at least one receptacle holder for conveying the receptacle relative to the filling station. At least one driving surface and at least one mover which can be coupled to the driving surface especially in a magnetic manner are provided, the mover being arranged so as to be movable and/or rotatable on the driving surface in at least two degrees of freedom. The receptacle holder is disposed on the mover.

US 2016/077120 A1 describes a laboratory sample distribution system having a recovery device and a laboratory automation system having such a laboratory sample distribution system. The recovery device is adapted to manipulate items such as sample container carriers or sample containers on a transport plane of the laboratory sample distribution system in the case of an error condition.

KR 2017 0033652 A discloses a gripper using magnetic levitation capable of easily moving an object in a dust-proof environment. The gripper using magnetic levitation comprises: a plurality of electromagnets arranged in a matrix form; a first grasping member floating on the electromagnets by magnetic force and having at least one first permanent magnet; and a second grasping member facing the first grasping member and floating on the electromagnets by magnetic force and having at least one second permanent magnet, wherein the electromagnets are connected to a current regulator for regulating a direction of a current applied to each of the electromagnets and intensity of a current.

U.S. Pat. No. 4,890,241 A describes a robotic system in which robot devices are assembled from an inventory of elements responsive to a work request. The robotic devices include robots incorporating two-dimensional, linear motors movable along a stationary platen and coupled to various power sources through flexible, extendible, umbilical cords. The robot devices are selectively connectible with manipulators for holding parts to be assembled and/or for performing operations on such parts and/or members to which such parts are mounted. The devices are automatically assembled by selecting elements capable of performing the tasks necessary to complete the work request as well as selecting those elements which result in optimization of the assembly time and avoid collisions and cord tangling in moving along the paths traversed by the robot devices during their assembly. A multiplicity of assembled robotic devices may perform the tasks associated with the work request under control of an electronic system permitting simultaneous operations while preventing collisions and cord tangling.

EP 0 601 213 A1 discloses transporting units that are magnetically suspended from a supporting plate. They are radio-controlled by a control device via a central transmitter/receiver. The transporting units are movable in the x-and y-direction and the goods-receiving member in the form of a pipette is displaceable in the z-direction. Each transporting unit has its own energy source which can be recharged in a charging station.

EP 0 414 643 A2 describes a technique for preventing a stalled linear motor device from damage including monitoring accelerometer servos which generate signals representative of the difference between a command acceleration signal controlling the linear motor and the actual acceleration experienced by the linear motor device which signal represents the acceleration error and the direction of the error. The different signal is compared against programmed limits to develop a break-loose signal when the programmed limit (positive or negative) is exceeded. The break-loose signal is monitored as to duration, which duration is preprogrammed according to the dynamics of the system specifications presently in use. In the event that the break-loose signal exceeds the preprogrammed time limit, a latch is set, generating an interrupt signal applied to the computer control which immediately removes all motive power from the system and tests the latch to determine the source of the error, the latch remaining in the set state awaiting the computer test and being reset only after recognition by the computer.

Despite the advantages achieved by the known methods and devices, several technical challenges remain in the field of laboratory systems. Specifically, known methods and devices for handling sample containers are usually limited in modularity by a fixed stroke length of their axes system. Further, for systems having only single grippers, throughput of these systems depends on the size of the system. Therefore, in order to increase throughput of these systems, generally, the size of the system has to be increased.

### Problem to be Solved

It is therefore desirable to provide devices and a method which at least partially address the above-mentioned technical challenges. Specifically, devices and a method shall be proposed which allow for a modular, flexible and customized automated handling of sample containers in a sample laboratory system.

### SUMMARY

This problem is addressed by a transfer device for transferring sample containers in a sample handling system, by a sample handling system for handling a plurality of sample containers and by a method for transferring sample containers in a sample handling system with the features of the independent claims. Advantageous embodiments which might be realized in an isolated fashion or in any arbitrary combinations are listed in the dependent claims as well as throughout the specification.

As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

Further, as used in the following, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

In a first aspect of the present invention, a transfer device for transferring sample containers in a sample handling system is disclosed.

The term “sample handling system” as used herein is a broad term and is to be given its ordinary and customary meaning to a person of ordinary skill in the art and is not to be limited to a special or customized meaning. The term specifically may refer, without limitation, to an arbitrary system comprising at least one component configured for performing at least one function of handling at least one sample contained by at least one sample container. The handling of samples may comprise at least one of: transporting samples in the sample handling system; analyzing samples; preparing samples for analysis, for example by splitting samples, mixing samples, adding one or more reagents, reactants or solvents to the samples. The handling may specifically be performed at least partially or even fully automatically. The sample, for example, may be a liquid sample contained by a sample container. In particular, the sample handling system may comprise a plurality of components which may be configured for interacting together to perform the at least one function of handling samples. Further, each of the components of the sample handling system may be configured for performing at least one function of handling samples. The sample handling system may be configured for performing a plurality of different functions of handling liquid samples. The sample handling system may specifically be configured for automatically handling samples, specifically for handling samples individually, such as one sample after another and/or a plurality of samples simultaneously. The sample handling system may be configured for handling a plurality of samples, specifically for handling a plurality of liquid samples contained by a plurality of sample containers. The sample handling system may be part of an automated laboratory, in particular of an automated workflow series.

The term “sample” as used herein is a broad term and is to be given its ordinary and customary meaning to a person of ordinary skill in the art and is not to be limited to a special or customized meaning. The term specifically may refer, without limitation, to an aliquot of a substance such as a chemical or biological compound. Specifically, the sample may be or may comprise at least one biological specimen, such as one or more of: blood; blood serum; blood plasma; urine; saliva. Additionally or alternatively, the sample may be or may comprise a chemical substance or compound and/or a reagent. The sample may specifically be a liquid sample, such as an aliquot of a fluid substance of the chemical or biological compound. For example, the liquid sample may be or may comprise at least one pure liquid, such as a liquid substance and/or a solution containing one or more liquid substances, comprising the at least one chemical and/or the biological substance. As another example, the liquid sample may be or may comprise a liquid mixture, such as a suspension, an emulsion and/or a dispersion of one or more chemical and/or biological substances. However, other, in particular non-liquid samples are also possible. Other sample types may be, for example, tissue or homogenized material.

The term “sample container” as used herein is a broad term and is to be given its ordinary and customary meaning to a person of ordinary skill in the art and is not to be limited to a special or customized meaning. The term specifically may refer, without limitation, to a receptacle configured for one or more of containing, storing and/or transporting a sample, specifically a liquid sample. Further, the sample container may be configured for being handled in the sample handling system. Specifically, the sample container may be used in the field of medical and/or chemical laboratories. For example, the sample container may be selected from the group consisting of: a vessel; a vial; a syringe; a cartridge; an ampoule; a tube. For example, the sample container may comprise a sample container body for containing the sample and a sample container closure, such as a cap for sealing the sample container. For example, the sample container may comprise a sample tube, wherein the sample tube, as an example, may be positioned in a sample container holder, with an open end pointing upwards. The sample tube may be an arbitrary individual container for transporting, storing and/or processing a content received by the sample tube. The sample tube may be a piece of laboratory glass-or plastic-ware optionally comprising a cap on its upper end. For example, the sample tube may be a glass or transparent plastic tube. The sample tube may be a cylindrical tube, e.g. a cylindrical tube having a circular and/or polygonal cross-section. For example, the sample container may be a reagent container. Other types or forms of sample containers are also possible.

The term “transferring” as used herein is a broad term and is to be given its ordinary and customary meaning to a person of ordinary skill in the art and is not to be limited to a special or customized meaning. The term specifically may refer, without limitation, to a process, specifically an automated process, of changing a sample containers' position and/or orientation, such as within the sample handling system. As an example, the transferring may comprise a re-positioning of the sample container, e.g. from one container receptacle into another and/or from a storage position into a processing or analysis position or vice versa. The process of transferring sample containers may comprise transferring single sample containers, specifically without using a sample container rack or sample container holder, or, alternatively, transferring multiple sample containers. The process of transferring may be performed automatically, in particular completely automatically. The process of transferring may be performed without interaction of a user or operator.

The term “transfer device” as used herein is a broad term and is to be given its ordinary and customary meaning to a person of ordinary skill in the art and is not to be limited to a special or customized meaning. The term specifically may refer, without limitation, to a device configured for transferring sample containers. The term “in” as used in the context of “in a sample handling system” shall be understood in that the transfer device either forms a part of the sample handling system or in that the transfer device is configured or suited for use in a sample handling system, for transferring samples or sample containers. The transfer device may be configured for transferring single sample containers or, alternatively, for transferring multiple sample containers, for example by having multiple gripper units and moving units as will be outlined in further detail below. Possible collisions between the multiple gripper units and moving units may be controlled by a control unit of the transfer device and/or may be absorbed by a mechanical damper arranged at one or more of the gripper units and the moving units. The transfer device may be configured for transferring sample containers within a transferring area. The transfer device may be a modular device. For example, the transfer device may be combined with one or more further transfer devices of similar kind. A combined transfer device comprising two or more transfer devices may have a combined transferring area.

The transfer device comprises:
at least one transport device comprising an array of electromagnetic actuators, specifically electromagnetic actuators comprising electromagnetic coils;
at least one moving unit comprising at least one permanent magnet, wherein the moving unit is movable in at least one movement plane, specifically in at least one movement plane of the moving unit defined by at least two moving directions, through the array by magnetic interaction of the permanent magnet with the electromagnetic actuators; and
at least one gripper unit for positioning at least one of the sample containers, wherein the gripper unit is movable in at least one gripping direction essentially perpendicular to the movement plane, wherein the gripping unit is attached to the moving unit.

The term “transport device” as used herein is a broad term and is to be given its ordinary and customary meaning to a person of ordinary skill in the art and is not to be limited to a special or customized meaning. The term specifically may refer, without limitation, to a device configured for moving, transporting, conveying, transferring and/or carrying objects from at least one first position into at least one second position different from the first position. The transport device may specifically be configured for moving the at least one moving unit of the transfer device. The movement may be a linear movement or a non-linear movement and may optionally also comprise a re-orientation of the moving unit. The transport device may be configured for moving a single moving unit or for moving a plurality of moving units. Specifically, the transport device may be configured for moving a plurality of moving units independently and/or separately from each other.

As outlined above, the transport device comprises the array of electromagnetic actuators. The term “electromagnetic actuator” as used herein is a broad term and is to be given its ordinary and customary meaning to a person of ordinary skill in the art and is not to be limited to a special or customized meaning. Therein, the term “actuator” specifically may refer to a device configured for exerting at least one action or force onto at least one object to be actuated, such as a mechanical action. The electromagnetic actuator, thus, specifically may be a device configured for exerting the at least one action or force by using electromagnetic principles. Specifically, the electromagnetic actuator may refer, without limitation, to a device configured for moving and/or controlling movement of at least one mechanism, device or system by generating at least one magnetic field when conducting at least one electric current. Specifically, the electromagnetic actuator may be configured for conducting electric current, thereby generating a magnetic field, wherein movement of the mechanism, device or system may be induced by interaction with the generated magnetic field. The generated magnetic field may apply a magnetic force to the mechanism, device or system to be moved. As an example, the electromagnetic actuator may be or may comprise at least one electromagnet and/or at least one electromagnetic coil. The electromagnetic actuator may comprise at least one electrically conducting wire wound into at least one electromagnetic coil, specifically an electromagnetic coil in the shape of a coil, spiral, helix or the like. The electromagnetic coil may specifically comprise the at least one electrically conducting wire being wound around at least one magnetic core, e.g. a core made from a ferromagnetic material, such as iron, cobalt, nickel, metallic alloys comprising iron, cobalt, nickel, and/or from a ferrimagnetic material, such as magnetite. The magnetic field generated by the electromagnetic actuator may be changeable in terms of magnetic field strength and/or magnetic field direction by controlling one or more of the applied electric current and a direction of flow of the applied electric current.

Each electromagnetic actuator may comprise an electromagnetic coil extending along an axis. The axes of the array of the electromagnetic actuators may be essentially parallel. Thus, the electromagnetic actuators, specifically all electromagnetic actuators, may extend from a first plane to a second plane. As an example, the transport device may comprise a bottom plate or an essentially planar bottom carrier, and optionally also a top plate or an essentially planar top carrier arranged in an essentially parallel fashion to the bottom plate or bottom carrier, with the array of electromagnetic actuators embedded or sandwiched in between these two plates or carriers, e.g. with the axes of the electromagnetic actuators oriented essentially perpendicular to the plates or carriers. The term “essentially”, as used herein, may imply angular tolerances, such as by no more than 30°, specifically no more than 10°, more specifically no more than 5°. Thus, the term “essentially parallel”, as used in the context of the axes of the electromagnetic coils, is a broad term and is to be given its ordinary and customary meaning to a person of ordinary skill in the art and is not to be limited to a special or customized meaning. The term specifically may refer, without limitation, to a situation in which the axes of the electromagnetic coils are parallel to each other or, alternatively, to a situation in which the axes of the electromagnetic coils deviate from a parallel orientation by no more than 30°, specifically no more than 10°, more specifically no more than 5°, relative to each other.

The term “array” as used herein is a broad term and is to be given its ordinary and customary meaning to a person of ordinary skill in the art and is not to be limited to a special or customized meaning. The term specifically may refer, without limitation, to an ordered arrangement of objects. A position and/or an orientation of the objects in the arrangement may be fixed relative to the other objects in the arrangement. Specifically, the array of electromagnetic actuators may comprise an ordered arrangement of the electromagnetic actuators, wherein a position and/or an orientation of the electromagnetic actuators relative to each other may be fixed. Thus, the electromagnetic actuators of the array may remain in a fixed position and/or in a fixed orientation while the moving unit, as will be outlined in further detail below, moves through the array. The electromagnetic actuators of the array may be of the same type or, alternatively, of a different type. The electromagnetic actuators of the array may be controllable independently from each other, such as by providing electric current to each of the electromagnetic actuators independently.

The array of electromagnetic actuators may comprise at least one array selected from the group consisting of: a matrix array, specifically a rectangular matrix array, a quadratic matrix array, a square matrix array and/or a linear matrix array; a circular array. The array, specifically the matrix array, more specifically any one of the above-mentioned matrix array, may also function as or be referred to as a transfer module. Specifically, a square matrix array may be provided and referred to as a transfer module or may form a transfer module. Multiple transfer modules may be organized in a modular fashion, such as a super-module, in order to form a continuous transfer surface and/or transfer plane. The at least one array of electromagnetic actuators may specifically comprise an array which can be combined with one or more further arrays of electromagnetic actuators in a modular fashion, specifically such that two or more arrays of electromagnetic actuators form a continuous movement plane. The electromagnetic actuators, in the array, may be arranged in an equidistant fashion, e.g. in a rectangular matrix pattern. The equidistant spacing may simplify simulations of the resulting magnetic fields. Other arrangements, however, having a non-equidistant spacing, are generally also feasible.

As further outlined above, the transfer device comprises the at least one moving unit comprising the at least one permanent magnet. The term “moving unit” as used herein is a broad term and is to be given its ordinary and customary meaning to a person of ordinary skill in the art and is not to be limited to a special or customized meaning. The term specifically may refer, without limitation, to a device performing and/or enabling movement through the array of the transport device. The moving unit may specifically comprise one or more components combined in a single unit. The one or more components of the moving unit may interact with each other for enabling movement through the array of the transport device. The movement of the moving unit through the array of the transport device may define the movement plane of the moving unit.

Consequently, the term “movement plane”, as used herein, may refer to a two-dimensional surface in which the movement of the moving unit takes place. The movement plane may be defined by the at least two moving directions of the moving unit. The moving direction may refer to a direction defined by a displacement of the moving unit through the array of electromagnetic actuators. The moving direction may describe a linear movement or, alternatively, a curvilinear movement of the moving unit. The at least two moving directions may comprise at least one first moving direction and at least one second moving direction. The first moving direction and the second moving direction may be at least partially linear independent from each other. The movement plane may be a flat surface or, alternatively, a curved surface. For example, in case the moving directions of the moving unit may describe a linear movement, the movement plane may be a flat surface. For example, in case the moving directions of the moving unit may describe a curvilinear movement, the movement plane may be a curved surface.

The term “permanent magnet” as used herein is a broad term and is to be given its ordinary and customary meaning to a person of ordinary skill in the art and is not to be limited to a special or customized meaning. The term specifically may refer, without limitation, to a magnetically active device, element or member. Specifically, the permanent magnet may be a magnetically active device, element or member of the moving unit. The permanent magnet may have magnetic characteristics, such as a magnetic moment, a magnetic field and/or a magnetic susceptibility. The permanent magnet may comprise at least one magnetic material, such as iron, nickel, cobalt, neodymium, samarium and/or metallic alloys thereof, for example alnico, a metallic alloy comprising iron, aluminum, nickel and cobalt. The permanent magnet, as a result of its magnetic characteristics, may be configured for interacting with a magnetic field. The magnetic characteristics of the permanent magnet may be constant in time. Thus, the magnetic characteristics of the permanent magnet may not change by not more than 10%, specifically by not more than 1%, more specifically by not more than 0.1%, relative to an initial value when the transfer device is put into operation. The permanent magnet may be configured, as a result of its magnetic characteristics, for magnetically interacting with the plurality of electromagnetic actuators of the transport device. The permanent magnet specifically may be oriented such that an axis of the permanent magnet is oriented essentially parallel to the axes of the electromagnetic coils or actuators. The permanent magnet specifically may have a cylindrical shape, such as a circular cylindrical shape, with circular end surfaces oriented essentially parallel to the movement plane or in the movement plane. The rounded shape may facilitate the movement of the permanent magnet and/or of the moving unit through the array and may avoid jamming of the magnet within the array. The electromagnetic actuators in the array, specifically, may be arranged such that the spaces between the electromagnetic actuators allow for a movement of the permanent magnet through the array, e.g. by separating neighboring electromagnetic actuators by more than the diameter or equivalent diameter of the magnet and/or of the moving unit. Thus, the array of electromagnetic actuators may form a grid through which the magnet and/or of the moving unit may move, driven by magnetic forces.

The term “magnetic interaction”, also referred to as “magnetically interacting”, as used herein is a broad term and is to be given its ordinary and customary meaning to a person of ordinary skill in the art and is not to be limited to a special or customized meaning. The term specifically may refer, without limitation, to a process of mutually acting or influencing via a magnetic field. The magnetic interaction may occur between at least two magnetically active devices or components. For example, the magnetic interaction may occur between the permanent magnet of the moving unit and the array of electromagnetic actuators. A magnetic force may be applied onto the magnetically interacting devices or components by the magnetic interaction. Specifically, a magnetic force may be applied from the array of electromagnetic actuators to the permanent magnet of the moving unit, and vice versa. However, a movement by application of the magnetic force may only be induced for the permanent magnet, specifically for the moving unit comprising the permanent magnet, as the array of electromagnetic actuators remains essentially stationary, specifically at least in the moving directions.

As further outlined above, the transfer device comprises the at least one gripper unit for positioning at least one of the sample containers, wherein the gripper unit is movable in the at least one gripping direction essentially perpendicular to the movement plane. The term “positioning” as used herein is a broad term and is to be given its ordinary and customary meaning to a person of ordinary skill in the art and is not to be limited to a special or customized meaning. The term specifically may refer, without limitation, to a process of at least one of lifting, holding, re-locating and re-orienting an object, e.g. for the purpose of transferring the object. The positioning of the sample container may involve a change of the sample container's position in the sample handling system. The positioning of the at least one sample container may specifically comprise loading the sample container using the gripper unit, for example from a sample container holder and/or from a sample container rack, holding the sample container while moving the moving with the attached the gripper unit to another position and unloading the sample container in the other position.

The term “gripper unit” as used herein is a broad term and is to be given its ordinary and customary meaning to a person of ordinary skill in the art and is not to be limited to a special or customized meaning. The term specifically may refer, without limitation, to a device configured for positioning at least one of the sample containers in the sample handling system. The gripper unit may be configured for holding at least one of the sample containers, such as by at least one of: mechanical forces, suction and magnetic forces. Thus, as an example, the gripper unit may comprise two or more gripper jaws. Additionally or alternatively, the gripper unit may comprise a suction unit. Again, additionally or alternatively, the gripper may comprise an electromagnetic or magnetic gripping actuator, such as an electromagnet. The gripper unit may be configured for lifting at least one of the sample containers. Lifting the sample container may specifically comprise moving the gripper unit from an elevated position downwards in the gripping direction towards the sample container, for example a sample container being conveyed by a sample transport system of the sample handling system, loading the sample container and/or moving backwards. The gripper unit may specifically be configured for positioning single sample containers. The gripper unit may comprise at least one of a mechanical gripper unit, a magnetic gripper unit, a suction gripper unit and an electric gripper unit.

The term “gripping direction” as used herein is a broad term and is to be given its ordinary and customary meaning to a person of ordinary skill in the art and is not to be limited to a special or customized meaning. The term specifically may refer, without limitation, to a direction of movement of the gripper unit, specifically when positioning sample containers. The gripping direction may be defined for a current position of the moving unit on the transport device, specifically in the array of electromagnetic actuators. For example, if the moving unit having the gripping unit attached thereto may be in a first position on the transport device, a corresponding first gripping direction may be different form a second gripping direction with the moving unit in a second position on the transport device different from the first position. However, the gripping direction may be essentially perpendicular to the movement plane in each position of the moving unit on the transport device.

The term “essentially perpendicular” as used herein is a broad term and is to be given its ordinary and customary meaning to a person of ordinary skill in the art and is not to be limited to a special or customized meaning. The term specifically may refer, without limitation, to a situation in which the gripping direction is perpendicular to the movement plane, i.e. having an angle of 90° with the movement plane, or, alternatively, to a situation in which the gripping direction forms an angle with the movement plane of at least 45°, specifically at least 80°, more specifically at least 85°. Thus, an angle formed by the gripping direction and the movement plane may be at least 45°, specifically at least 80°, more specifically at least 85°, even more specifically 90°. The angle formed by the gripping direction and the movement plane may be dependent on a current position of the moving unit with the attached gripping unit on the transport device. For example, in a three-dimensional coordinate system, the movement plane of the moving unit may lie in an x-y-plane, whereas the gripping direction may be in z-direction.

The moving unit and the gripper unit attached thereto may form a movable positioning unit. The transport device may comprise at least one guiding element configured for guiding the positioning unit. The guiding element may specifically comprise at least one guiding slot, specifically a plurality or a grid of guiding slots. The positioning unit may be movable through the array by moving through the guiding slot.

The transport device may comprise at least one bearing element configured for bearing the positioning unit. Alternatively or additionally, the moving unit may comprise the bearing element configured for bearing the positioning unit, specifically at least one bearing element for enabling movement of the positioning unit along the at least one guiding element. However, other examples, such as a bearing element comprised by the guiding element of the transport device, may also be feasible. The bearing element may comprise at least one bearing for enabling movement of the moving unit. The bearing element may comprise at least one of: a linear-motion bearing; a sliding contact bearing; a friction bearing; a plain bearing; a roller-element bearing, specifically a ball bearing and/or a roller bearing.

The transfer device may comprise at least one control unit for controlling operation of the transfer device. The term “control unit” as used herein is a broad term and is to be given its ordinary and customary meaning to a person of ordinary skill in the art and is not to be limited to a special or customized meaning. The term specifically may refer, without limitation, to a device, such a single device or a plurality of devices, comprising at least one computational element, such as at least one processor. As used herein, the term “processor” may refer to an arbitrary logic circuitry configured for performing basic operations of a computer or system, and/or, generally, to a device which is configured for performing calculations or logic operations. In particular, the processor may be configured for processing basic instructions that drive the computer or system. As an example, the processor may comprise at least one arithmetic logic unit (ALU), at least one floating-point unit (FPU), such as a math coprocessor or a numeric coprocessor, a plurality of registers, specifically registers configured for supplying operands to the ALU and storing results of operations, and a memory, such as an L1 and L2 cache memory. In particular, the processor may be a multi-core processor. Specifically, the processor may be or may comprise a central processing unit (CPU). Specifically, the processor may be or may comprise at least one Graphics Processing Unit (GPU). Additionally or alternatively, the processor may be or may comprise a microprocessor, thus specifically the processor's elements may be contained in one single integrated circuitry (IC) chip. Additionally or alternatively, the processor may be or may comprise one or more application-specific integrated circuits (ASICs) and/or one or more field-programmable gate arrays (FPGAs) and/or one or more tensor processing unit (TPU) and/or one or more chip, such as a dedicated machine learning optimized chip, or the like. The control unit specifically may be configured, such as by software programming, for performing one or more control operations, such as controlling moving of the moving unit and/or controlling positioning using the gripper unit.

The control unit may be configured for positioning the sample containers by using the gripping unit and/or for controlling movement of the moving unit through the array, specifically by controlling electric currents applied to the array of electromagnetic actuators. Additionally or alternatively, the control unit may be configured for driving the electromagnetic actuators such that a resulting magnetic field is generated in the movement plane of the moving unit driving the permanent magnet of the moving unit into at least one target direction by magnetic forces. In addition, the control unit may also be configured for controlling one or more other actions of the transfer device. Thus, the control unit may also be configured for controlling a gripping action of the at least one gripper unit, such as by controlling an opening and/or closing movement of one or more gripper elements such as jaws of a gripper, controlling a suction action of the gripper unit or controlling an electromagnetic gripping action. Further, additionally or alternatively, the control unit may also be configured for controlling a movement of the gripper unit in the gripping direction, such as a movement essentially perpendicular to the movement plane.

The control unit may be configured for determining, e.g. calculating, a desired or required resulting electromagnetic field generated by the electromagnetic actuators and may directly or indirectly control the electromagnetic actuators to generate the desired or required resulting electromagnetic field. Thus, as an example, a desired direction or path of movement of the movable positioning unit and/or an acceleration thereof may be given or determined, e.g. by a computer program and/or by a user input. The control unit may determine the electromagnetic actuators required for achieving said required electromagnetic field and may control the electromagnetic actuators accordingly. As an example, for generating the desired or required electromagnetic field, a lookup-table may be used, having listed therein currents for achieving a desired movement of the movable positioning unit. Additionally or alternatively, more complex algorithms may be used, such as by using software simulations. Various alternatives are feasible.

The moving unit may be configured for resting if a combined magnetic field generated by the array of electromagnetic actuators comprises opposed magnetic field components in the movement plane, specifically in at least one of the moving directions. Thus, for each magnetic field component in the movement plane, at least one magnetic field component may exist opposing the magnetic field component in the movement plane resulting in a vanishing combined magnetic field strength in the movement plane.

The moving unit may be configured for moving in the movement plane if a combined magnetic field generated by the array of electromagnetic actuators comprises at least one non-opposed magnetic field component in the movement plane, specifically in at least one of the moving directions.

Each electromagnetic actuator may have at least two operating states. A first operating state may be a state of reduced magnetic field, specifically of zero magnetic field. A second operating state may be a state of enhanced magnetic field. The operating states of the electromagnetic actuators may be controllable independently from each other, specifically by applying an electric current to each electromagnetic actuator separately.

Additionally or alternatively, each electromagnetic actuator may have a third operating state. The third operating state may be a state of reversed magnetic field compared with the second operating state. The permanent magnet may be movable in the gripping direction if electromagnetic actuators adjacent to the moving unit are in the third operating state. The adjacent electromagnetic actuators may specifically comprise nearest neighbor electromagnetic actuators at a current position of the moving unit in the array. Additionally, the gripper unit may be attached to the permanent magnet of the moving unit. Thus, in this example, the gripper unit may be movable in the gripping direction by moving the permanent magnet in the gripping direction.

Alternatively or additionally, the gripper unit may comprise at least one linear actuator. The linear actuator may be movable in the gripping direction. The linear actuator may comprise at least one of: an electric actuator, specifically an electric motor, more specifically a dual motion motor; a pneumatic actuator; a hydraulic actuator.

In a further aspect of the present invention, a sample handling system for handling a plurality of sample containers is disclosed. For definitions and embodiments, for example of the transfer device, reference is made to the definitions and embodiments as outlined in the context of the transfer device.

The sample handling system comprises at least one transfer device for transferring the sample containers in the sample handling system according to the present invention, such as according to any one of the embodiments disclosed above and/or according to any one of the embodiments disclosed in further detail below. Further, the sample handling system comprises at least one sample transport device for transporting the sample containers.

The sample transport device may be configured for transporting sample containers in the sample handling system. The sample transport device may have at least one sample transport plane on which the sample containers are transported. The movement plane of the transfer device may be essentially parallel to the at least one sample transport plane of the sample transport device. The term “essentially parallel”, as used in the context of the movement plane, is a broad term and is to be given its ordinary and customary meaning to a person of ordinary skill in the art and is not to be limited to a special or customized meaning. The term specifically may refer, without limitation, to a situation in which the movement plane is parallel to the sample transport plane or, alternatively, to a situation in which the movement plane forms an angle with the sample transport plane of no more than 45°, specifically no more than 10°, more specifically no more than 5°.

The transfer device may specifically be arranged above at least one device comprised by the sample handling system. The at least one device specifically may be selected from the group consisting of: the sample transport device for transporting the sample containers in the sample handling system; an analytical device for analyzing samples in the sample handling system; an input device for introducing the sample containers to the sample handling system; an output device for removing the sample containers from the sample handling system.

The transfer device may be configured for transferring the sample containers in between at least two devices comprised by the sample handling system. The at least two devices specifically may be selected from the group consisting of: the sample transport device for transporting the sample containers in the sample handling system; an analytical device for analyzing samples in the sample handling system; an input device for introducing the sample containers to the sample handling system; an output device for removing the sample containers from the sample handling system.

In a further aspect of the present invention, a method for transferring sample containers in a sample handling system is disclosed. For definitions and embodiments, for example of the transfer device, reference is made to the definitions and embodiments as outlined in the context of the transfer device.

The method comprises the following steps which, specifically, may be performed in the given order. It shall be noted, however, that a different order is also possible. Further, it is also possible to perform one or more of the method steps once or repeatedly. Further, it is possible to perform two or more of the method steps simultaneously or in a timely overlapping fashion. The method may comprise further method steps which are not listed.

The method comprises:
i) providing at least one transfer device according to the present invention, such as according to any one of the embodiments disclosed above and/or according to any one of the embodiments disclosed in further detail below;
ii) transferring the sample containers in the sample handling system by moving the at least one moving unit in the at least one movement plane, specifically in at least one movement plane defined by at least two moving directions, through the array of electromagnetic actuators by magnetic interaction of the at least one permanent magnet with the electromagnetic actuators and positioning the sample containers by using the at least one gripper unit.

Specifically, the transferring of the sample containers may be at least partially computer-controlled. For example, the transferring of the sample containers may be at least partially controlled by the control unit of the transfer device.

The devices and method according to the present invention provide a large number of advantages over known methods and devices of similar kind. Specifically, the transfer device may use the current transport technology of the sample transport device of the sample handling system for moving the moving unit together with the gripper unit for transferring sample container in the sample handling system. The transfer device may provide a compact system for transferring sample containers. The transfer device may be a modular device providing highly flexible and variable standardized units. Thus, for example, it may be possible to expand the transferring area by combining multiple transfer devices to a combined transfer device. The transfer device may therefore be able to meet any size constraints in the sample handling system. Further, it may be possible to use more than a single gripping unit at the transfer device. The transfer device may provide means for multiple and independent sample container handling thereby achieving a high throughput with a single compact transfer device.

Further, movement of the moving unit may be based on magnetic interaction with the array of electromagnetic actuators as an operating state of the electromagnetic actuators may alternate between a first operating state of no electric current and a second operating state of an electric current, for example resulting in N-S polarity. By turning the electromagnetic actuators on and off in a purposeful manner, the moving unit and the gripping unit attached thereto may navigate through the array of electromagnetic actuators along the x-y plane above a workspace of the sample handling system. The transverse movement of the gripper unit in the gripping direction, for example along the z-axis, may occur by a linear actuator such as a dual motion motor comprised by the gripping unit. Alternatively or additionally, a third operating state using an electric current that results in an opposite polarity compared with the second operating state may drive movement of the gripping unit in the gripping direction, for example along the z-axis. By switching between the second and the third operating state, the permanent magnet comprised by the moving unit may alternate between a lower position and a higher position used to lift a selected sample container.

Summarizing and without excluding further possible embodiments, the following embodiments may be envisaged:

Embodiment 1: A transfer device for transferring sample containers in a sample handling system, wherein the transfer device comprises:
at least one transport device comprising an array of electromagnetic actuators, specifically electromagnetic actuators comprising electromagnetic coils;
at least one moving unit comprising at least one permanent magnet, wherein the moving unit is movable in at least one movement plane, specifically in at least one movement plane of the moving unit defined by at least two moving directions, through the array by magnetic interaction of the permanent magnet with the electromagnetic actuators; and
at least one gripper unit for positioning at least one of the sample containers, wherein the gripper unit is movable in at least one gripping direction essentially perpendicular to the movement plane, wherein the gripping unit is attached to the moving unit.

Embodiment 2: The transfer device according to the preceding embodiment, wherein the array of electromagnetic actuators comprises at least one array selected from the group consisting of: a matrix array, specifically a rectangular matrix array, a quadratic matrix array, a square matrix array and/or a linear matrix array; a circular array.

Embodiment 3: The transfer device according to any one of the preceding embodiments, wherein each electromagnetic actuator comprises an electromagnetic coil extending along an axis, wherein the axes of the array of the electromagnetic actuators are essentially parallel.

Embodiment 4: The transfer device according to any one of the preceding embodiments, wherein the moving unit and the gripper unit attached thereto form a movable positioning unit.

Embodiment 5: The transfer device according to the preceding embodiment, wherein the transport device comprises at least one guiding element configured for guiding the positioning unit.

Embodiment 6: The transfer device according to the preceding embodiment, wherein the guiding element comprises at least one guiding slot, specifically a plurality or a grid of guiding slots, wherein the positioning unit is movable through the array by moving through the guiding slot.

Embodiment 7: The transfer device according to any one of the three preceding embodiments, wherein the transport device comprises at least one bearing element configured for bearing the positioning unit.

Embodiment 8: The transfer device according to any one of the four preceding embodiments, wherein the moving unit comprises at least one bearing element configured for bearing the positioning unit, specifically at least one bearing element for enabling movement of the positioning unit along the at least one guiding element.

Embodiment 9: The transfer device according to any one of the two preceding embodiments, wherein the bearing element comprises at least one bearing for enabling movement of the moving unit.

Embodiment 10: The transfer device according to any one of the three preceding embodiments, wherein the bearing element comprises at least one of: a linear-motion bearing; a sliding contact bearing; a friction bearing; a plain bearing; a roller-element bearing, specifically a ball bearing and/or a roller bearing.

Embodiment 11: The transfer device according to any one of the preceding embodiments, wherein the transfer device comprises at least one control unit for controlling operation of the transfer device.

Embodiment 12: The transfer device according to the preceding embodiment, wherein the control unit is configured for positioning the sample containers by using the gripping unit and/or for controlling movement of the moving unit through the array, specifically by controlling electric currents applied to the array of electromagnetic actuators.

Embodiment 13: The transfer device according to any one of the two preceding embodiments, wherein the control unit is configured for driving the electromagnetic actuators such that a resulting magnetic field is generated in the movement plane of the moving unit driving the permanent magnet of the moving unit into at least one target direction by magnetic forces.

Embodiment 14: The transfer device according to any one of the preceding embodiments, wherein the moving unit is configured for resting if a combined magnetic field generated by the array of electromagnetic actuators comprises opposed magnetic field components in the movement plane, specifically in at least one of the moving directions.

Embodiment 15: The transfer device according to any one of the preceding embodiments, wherein the moving unit is configured for moving in the movement plane if a combined magnetic field generated by the array of electromagnetic actuators comprises at least one non-opposed magnetic field component in the movement plane, specifically in at least one of the moving directions.

Embodiment 16: The transfer device according to any one of the preceding embodiments, wherein each electromagnetic actuator has at least two operating states, wherein a first operating state is a state of reduced magnetic field, specifically of zero magnetic field, wherein a second operating state is a state of enhanced magnetic field.

Embodiment 17: The transfer device according to the preceding embodiment, wherein the operating states of the electromagnetic actuators are controllable independently from each other, specifically by applying an electric current to each electromagnetic actuator separately.

Embodiment 18: The transfer device according to any one of the two preceding embodiments, wherein each electromagnetic actuator has a third operating state, wherein the third operating state is a state of reversed magnetic field compared with the second operating state.

Embodiment 19: The transfer device according to the preceding embodiment, wherein the permanent magnet is movable in the gripping direction if electromagnetic actuators adjacent to the moving unit are in the third operating state.

Embodiment 20: The transfer device according to the preceding embodiment, wherein the gripper unit is attached to the permanent magnet of the moving unit.

Embodiment 21: The transfer device according to any one of the preceding embodiments, wherein the gripper unit comprises at least one linear actuator, wherein the linear actuator is movable in the gripping direction.

Embodiment 22: The transfer device according to the preceding embodiment, wherein the linear actuator comprises at least one of: an electric actuator, specifically an electric motor, more specifically a dual motion motor; a pneumatic actuator; a hydraulic actuator.

Embodiment 23: The transfer device according to any one of the preceding embodiments, wherein the gripper unit comprises at least one of a mechanical gripper unit, a magnetic gripper unit, a suction gripper unit and an electric gripper unit.

Embodiment 24: The transfer device according to any one of the preceding embodiments, wherein the gripper unit is configured for positioning single sample containers.

Embodiment 25: The transfer device according to any one of the preceding embodiments, wherein an angle formed by the gripping direction and the movement plane is at least 45°, specifically at least 80°, more specifically at least 85°, even more specifically 90°.

Embodiment 26: A sample handling system for handling a plurality of sample containers, wherein the sample handling system comprises at least one transfer device for transferring the sample containers in the sample handling system according to any one of the preceding embodiments and at least one sample transport device for transporting the sample containers.

Embodiment 27: The sample handling system according to the preceding embodiment, wherein the movement plane of the transfer device is essentially parallel to at least one sample transport plane of the sample transport device.

Embodiment 28: The sample handling system according to any one of the two preceding embodiments, wherein the transfer device is arranged above at least one device comprised by the sample handling system, wherein the at least one device is selected from the group consisting of: the sample transport device for transporting the sample containers in the sample handling system; an analytical device for analyzing samples in the sample handling system; an input device for introducing the sample containers to the sample handling system; an output device for removing the sample containers from the sample handling system.

Embodiment 29: The sample handling system according to any one of the three preceding embodiments, wherein the transfer device is configured for transferring the sample containers in between at least two devices comprised by the sample handling system, wherein the at least two devices are selected from the group consisting of: the sample transport device for transporting the sample containers in the sample handling system; an analytical device for analyzing samples in the sample handling system; an input device for introducing the sample containers to the sample handling system; an output device for removing the sample containers from the sample handling system.

Embodiment 30: A method for transferring sample containers in a sample handling system, the method comprising:
i) providing at least one transfer device according to any one of the preceding embodiments referring to a transfer device;
ii) transferring the sample containers in the sample handling system by moving the at least one moving unit in the at least one movement plane, specifically in at least one movement plane defined by at least two moving directions, through the array of electromagnetic actuators by magnetic interaction of the at least one permanent magnet with the electromagnetic actuators and positioning the sample containers by using the at least one gripper unit.

Embodiment 31: The method according to the preceding embodiment, wherein the transferring of the sample containers is at least partially computer-controlled.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements. In the Figures:

FIGS. 1 to 3 show different embodiments of a transfer device for transferring sample containers in a sample handling system and of a sample handling system for handling a plurality of sample containers in a perspective view;

FIGS. 4A to 4C show different operating states of an electromagnetic actuator in a side view;

FIGS. 5A to 5C show a part of an embodiment of an array of electromagnetic actuators in a top view;

FIGS. 6A and 6B show a part of an embodiment of a transport device in a side view; and

FIG. 7 shows a flow chart of an embodiment of a method for transferring sample containers in a sample handling system.

### DETAILED DESCRIPTION OF THE EMBODIMENTS

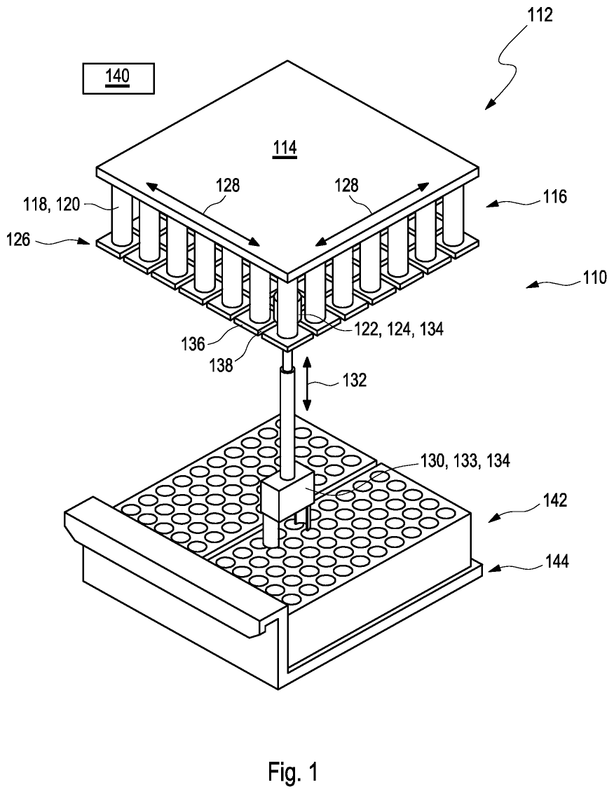

FIG. 1 shows a first exemplary embodiment of a transfer device 110 for transferring sample containers (not shown in the Figures) in a sample handling system 112 and of a sample handling system 112 for handling a plurality of sample containers in a perspective view.

The transfer device 110 comprises at least one transport device 114 comprising an array 116 of electromagnetic actuators 118, specifically electromagnetic actuators 118 comprising electromagnetic coils 120. In the exemplary embodiment of FIG. 1, each electromagnetic actuator 118 may comprise the electromagnetic coil 120 extending along an axis. The axes of the array 116 of the electromagnetic actuators 118 may be essentially parallel. As shown in FIG. 1, the array 116 of electromagnetic actuators 118 may comprise a matrix array, specifically a quadratic matrix array or a square matrix array. However, other types of arrays 116, such as a rectangular matrix array, a linear matrix array and/or a circular array, are also feasible.

The transfer device 110 further comprises at least one moving unit 122 comprising at least one permanent magnet 124. The moving unit 122 is movable in at least one movement plane 126, specifically in at least one movement plane 126 of the moving unit 122 defined by at least two moving directions 128, through the array 116 by magnetic interaction of the permanent magnet 124 with the electromagnetic actuators 118.

The transfer device 110 comprises at least one gripper unit 130 for positioning at least one of the sample containers. The gripper unit 130 is movable in at least one gripping direction 132 essentially perpendicular to the movement plane 126. As can be seen in FIG. 1, an angle formed by the gripping direction 132 and the movement plane 126 may be 90°. However, other angles, such as an angle of at least 45°, specifically at least 80°, more specifically at least 85°, are also feasible. The gripping unit 130 is attached to the moving unit 122. The gripper unit 130 may specifically be configured for positioning single sample containers. In the exemplary embodiment of FIG. 1, the gripper unit 130 may comprise at least one mechanical gripper unit 133. However, other types of gripper units 130, such as a magnetic gripper unit, an electric gripper unit and/or a suction gripper unit are also feasible.

The moving unit 122 and the gripper unit 130 attached thereto may form a movable positioning unit 134. The transport device 114 may comprise at least one guiding element 136 configured for guiding the positioning unit 134. The guiding element 136 may specifically comprise at least one guiding slot 138, specifically a plurality or a grid of guiding slots 138. The positioning unit 134 may be movable through the array 116 by moving through the guiding slot 138.

As schematically shown in FIG. 1, the transfer device 110 may comprise at least one control unit 140 for controlling operation of the transfer device 110. The control unit 140 may be configured for positioning the sample containers by using the gripping unit 130 and/or for controlling movement of the moving unit 122 through the array 116, specifically by controlling electric currents applied to the array 116 of electromagnetic actuators 118. Additionally or alternatively, the control unit 140 may be configured for driving the electromagnetic actuators 118 such that a resulting magnetic field is generated in the movement plane 126 of the moving unit 122 driving the permanent magnet 124 of the moving unit 122 into at least one target direction by magnetic forces.

The sample handling system 112 for handling a plurality of sample containers comprises the at least one transfer device 110 for transferring the sample containers in the sample handling system 112 and at least one sample transport device 142 for transporting the sample containers. The sample transport device 142 may be configured for transporting sample containers in the sample handling system 112. The sample transport device 142 may have at least one sample transport plane 144 on which the sample containers are transported. The movement plane 126 of the transfer device 110 may be essentially parallel to the at least one sample transport plane 144 of the sample transport device 142.

As can be seen in FIG. 1, the transfer device 110 may specifically be arranged above the sample transport device 142 for transporting the sample containers in the sample handling system 112. However, the transfer device 110, alternatively or additionally, may be arranged above one or more further devices of the sample handling system 112, such as above an analytical device for analyzing samples in the sample handling system 112, above an input device for introducing the sample containers to the sample handling system 112 and/or above an output device for removing the sample containers from the sample handling system 112. The transfer device 110 may be configured for transferring the sample containers in between at least two devices thereof.

FIGS. 2 and 3 show further exemplary embodiments of the transfer device 110 for transferring sample containers in the sample handling system 112 and of the sample handling system 112 for handling a plurality of sample containers in a perspective view. The embodiments of FIGS. 2 and 3 of the transfer device 110 may correspond widely to the embodiment of the transfer device 110 shown in FIG. 1. Thus, for the description of FIGS. 2 and 3, reference is made to the description of FIG. 1.

As can be seen in FIG. 2, the transfer device 110 may comprise multiple gripper units 130 and moving units 122. For example, the transfer device 110 may comprise two gripper units 130 each being attached to one moving unit 122, thereby forming two positioning units 134. However, more than two positioning units 134 are also feasible. Thus, the transfer device 110 may be configured for transferring multiple sample containers.

The transfer device 110 may be configured for transferring sample containers within a transferring area. The transfer device 110 may be a modular device. As shown in FIG. 3, the transfer device 110 may be combined with one or more further transfer devices 110 of similar kind. A combined transfer device 110 comprising two or more transfer devices 110 may have a combined transferring area.

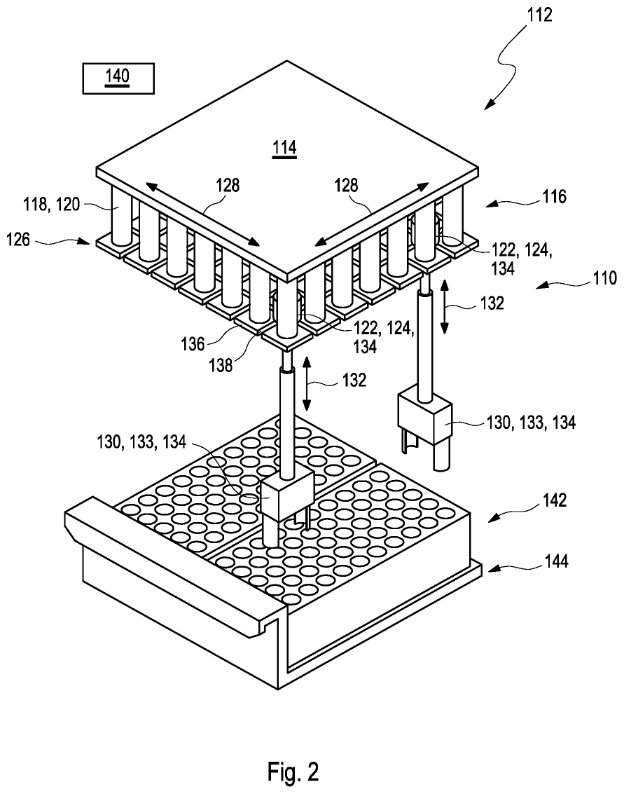

FIGS. 4A to 4C show different operating states of the electromagnetic actuator 118 in a side view. In the exemplary embodiment of FIGS. 4A to 4C, the electromagnetic actuator 118 comprises the electromagnetic coil 120, specifically being wound around a magnetic core 146 made from a ferromagnetic material or a ferrimagnetic material.

Each electromagnetic actuator 118 may have at least two operating states. A first operating state 148, as exemplarily shown in FIG. 4A, may be a state of reduced magnetic field, specifically of zero magnetic field. A second operating state 150, as exemplarily shown in FIG. 4B, may be a state of enhanced magnetic field. The operating states of the electromagnetic actuators 118 may be controllable independently from each other, specifically by applying an electric current to each electromagnetic actuator 118 separately. Additionally or alternatively, each electromagnetic actuator 118 may have a third operating state 152. The third operating state 152, as exemplarily shown in FIG. 4C, may be a state of reversed magnetic field compared with the second operating state 150.

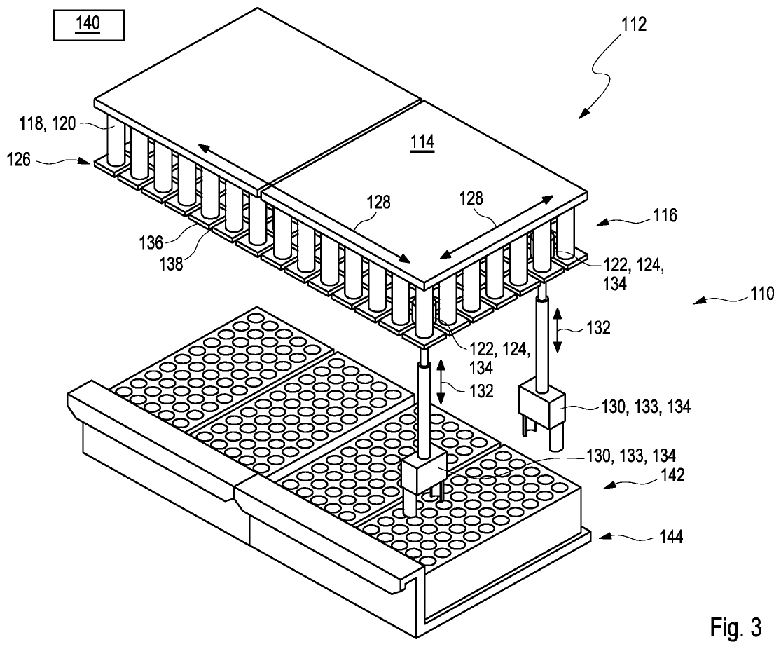

FIGS. 5A to 5C show a part of an exemplary embodiment of the array 116 of electromagnetic actuators 118 in a top view. In FIGS. 5A to 5C, an exemplary movement of the moving unit 122 comprising the permanent magnet 124 through the array 116 of electromagnetic actuators 118 is shown. The array 116 may comprise a part of the electromagnetic actuators 118 in the first operating state 148 and another part of the electromagnetic actuators 118 in the second operating state 150.

The moving unit 122 may be configured for resting, as exemplarily shown in FIG. 5A, if a combined magnetic field generated by the array 116 of electromagnetic actuators 118 comprises opposed magnetic field components in the movement plane 126, specifically in at least one of the moving directions 128. Thus, for each magnetic field component in the movement plane 126, at least one magnetic field component may exist opposing the magnetic field component in the movement plane 126 resulting in a vanishing combined magnetic field strength in the movement plane 126

The moving unit 122 may be configured for moving in the movement plane 126, as exemplarily shown in FIGS. 5B and 5C, if a combined magnetic field generated by the array 116 of electromagnetic actuators 118 comprises at least one non-opposed magnetic field component in the movement plane 126, specifically in at least one of the moving directions 128.

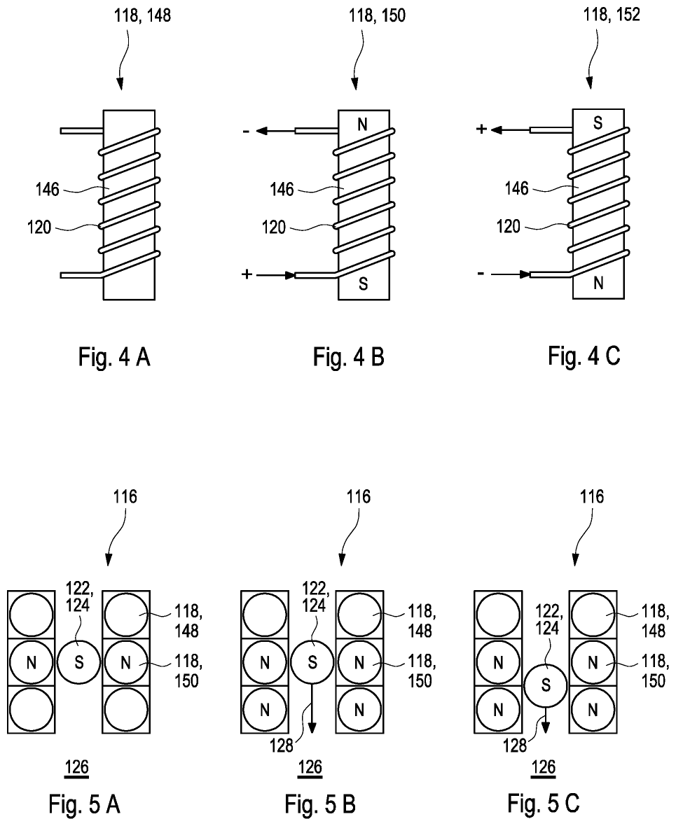

FIGS. 6A and 6B show a part of an exemplary embodiment of the transport device 114 in a side view. The transport device 114 shown in FIGS. 6A and 6B may specifically be used in the transfer device 110 according to the present invention, for example according to any one of the embodiments described in FIGS. 1 to 3.

The transport device 114 may comprise at least one bearing element 154 configured for bearing the positioning unit 134. Alternatively or additionally, the moving unit 122 may comprise the bearing element 154 configured for bearing the positioning unit 134, specifically at least one bearing element 154 for enabling movement of the positioning unit 134 along the at least one guiding element 136. However, other examples, such as a bearing element 154 comprised by the guiding element 136 of the transport device 114, may also be feasible. As shown in FIG. 6A, the bearing element 154 may comprise at least one bearing 156 for enabling movement of the moving unit 122. In the exemplary embodiment of FIGS. 6A and 6B, the bearing element 154 may comprise at least one sliding contact bearing 158. However, other bearing elements 154, such as a linear-motion bearing, a friction bearing, a plain bearing, a roller-element bearing, specifically a ball bearing and/or a roller bearing, are also feasible.

As further can be seen in FIGS. 6A and 6B, the permanent magnet 124 may be movable in the gripping direction 132 if electromagnetic actuators 118 adjacent to the moving unit 122 are in the third operating state 152. Additionally, the gripper unit 130 may be attached to the permanent magnet 124 of the moving unit 122. Thus, in this example, the gripper unit 130 may be movable in the gripping direction 132 by moving the permanent magnet 124 in the gripping direction 132.

Alternatively or additionally, the gripper unit 130 may comprise at least one linear actuator (not shown in the Figures). The linear actuator may be movable in the gripping direction 132. The linear actuator may comprise at least one of: an electric actuator, specifically an electric motor, more specifically a dual motion motor; a pneumatic actuator; a hydraulic actuator.

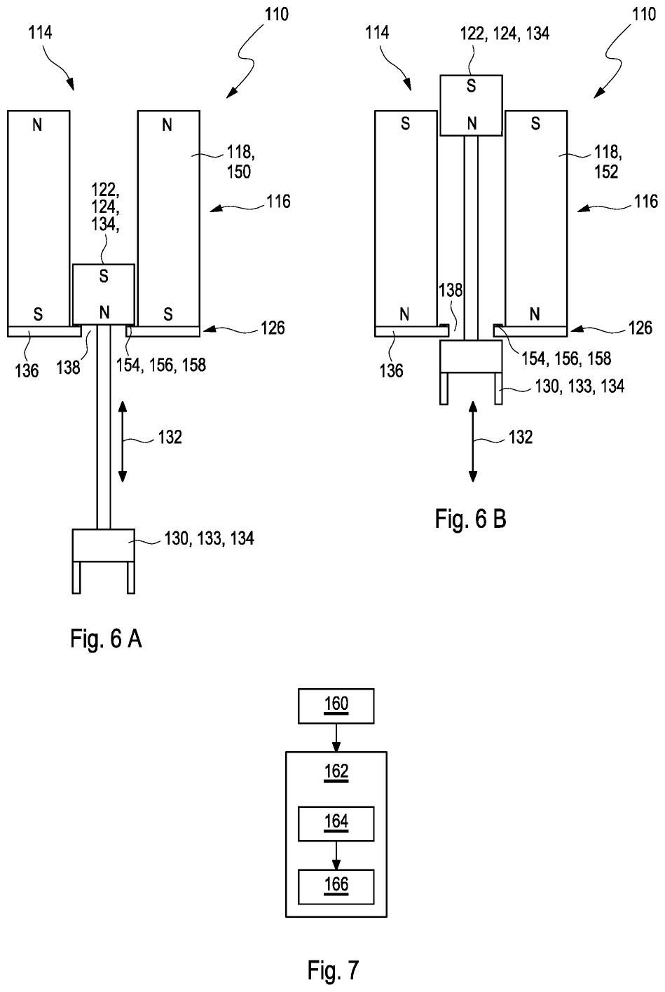

In FIG. 7, a flow chart of an exemplary embodiment of a method for transferring sample containers in the sample handling system 112 is shown. The method comprises the following steps which, as an example, may be performed in the given order. It shall be noted, however, that a different order is also possible. Further, it is also possible to perform one or more of the method steps once or repeatedly. Further, it is possible to perform two or more of the method steps simultaneously or in a timely overlapping fashion. The method may comprise further method steps which are not listed.

The method comprises:
i) (denoted by reference number 160) providing the at least one transfer device 110 according to the present invention, such as according to any one of the embodiments disclosed above and/or according to any one of the embodiments disclosed in further detail below;
ii) (denoted by reference number 162) transferring the sample containers in the sample handling system 112 by moving the at least one moving unit 122 in the at least one movement plane 126 (denoted by reference number 164), specifically in at least one movement plane 126 defined by at least two moving directions 128, through the array 116 of electromagnetic actuators 118 by magnetic interaction of the at least one permanent magnet 124 with the electromagnetic actuators 118 and positioning the sample containers by using the at least one gripper unit 130 (denoted by reference number 166).
   Specifically, the transferring of the sample containers may be at least partially computer-controlled. For example, the transferring of the sample containers may be at least partially controlled by the control unit 140 of the transfer device 110.

### LIST OF REFERENCE NUMBERS

110 transfer device
112 sample handling system
114 transport device
116 array
118 electromagnetic actuators
120 electromagnetic coils
122 moving unit
124 permanent magnet
126 movement plane
128 moving directions
130 gripper unit
132 gripping direction
133 mechanical gripper unit
134 positioning unit
136 guiding element
138 guiding slot
140 control unit
142 sample transport device
144 sample transport plane
146 magnetic core
148 first operating state
150 second operating state
152 third operating state
154 bearing element
156 bearing
158 sliding contact bearing
160 providing at least one transfer device
162 transferring the sample containers in the sample handling system
164 moving the moving unit
166 positioning the sample containers

1. A transfer device for transferring sample containers in a sample handling system, wherein the transfer device comprises:
at least one transport device comprising an array of electromagnetic actuators;
at least one moving unit comprising at least one permanent magnet, wherein the moving unit is movable in at least one movement plane through the array by magnetic interaction of the permanent magnet with the electromagnetic actuators; and
at least one gripper unit for positioning at least one of the sample containers, wherein the gripper unit is movable in at least one gripping direction essentially perpendicular to the movement plane, wherein the gripping unit is attached to the moving unit.

2. The transfer device according to claim 1, wherein each electromagnetic actuator comprises an electromagnetic coil extending along an axis, wherein the axes of the array of the electromagnetic actuators are essentially parallel.

3. The transfer device according to claim 1, wherein the moving unit and the gripper unit attached thereto form a movable positioning unit, wherein the transport device comprises at least one guiding element configured for guiding the positioning unit.

4. The transfer device according to claim 3, wherein the guiding element comprises at least one guiding slot, wherein the positioning unit is movable through the array by moving through the guiding slot.

5. The transfer device according to claim 3, wherein the transport device comprises at least one bearing element configured for bearing the positioning unit.

6. The transfer device according to claim 3, wherein the moving unit comprises at least one bearing element configured for bearing the positioning unit.

7. The transfer device according to claim 1, wherein the transfer device comprises at least one control unit for controlling operation of the transfer device, wherein the control unit is configured for positioning the sample containers by using the gripping unit and/or for controlling movement of the moving unit through the array.

8. The transfer device according to claim 7, wherein the control unit is configured for driving the electromagnetic actuators such that a resulting magnetic field is generated in the movement plane of the moving unit driving the permanent magnet of the moving unit into at least one target direction by magnetic forces.

9. The transfer device according to claim 1, wherein each electromagnetic actuator has at least two operating states, wherein a first operating state is a state of reduced magnetic field, wherein a second operating state is a state of enhanced magnetic field, wherein the operating states of the electromagnetic actuators are controllable independently from each other.

10. The transfer device according to claim 9, wherein each electromagnetic actuator has a third operating state, wherein the third operating state is a state of reversed magnetic field compared with the second operating state, wherein the permanent magnet is movable in the gripping direction if electromagnetic actuators adjacent to the moving unit are in the third operating state, wherein the gripper unit is attached to the permanent magnet of the moving unit.

11. The transfer device according to claim 1, wherein the gripper unit comprises at least one linear actuator, wherein the linear actuator is movable in the gripping direction, wherein the linear actuator comprises at least one of: an electric actuator; a pneumatic actuator; a hydraulic actuator.

12. The transfer device according to claim 1, wherein the gripper unit is configured for positioning single sample containers.

13. A sample handling system for handling a plurality of sample containers, wherein the sample handling system comprises at least one transfer device for transferring the sample containers in the sample handling system according to claim 1 and at least one sample transport device for transporting the sample containers.

14. The sample handling system according to claim 13, wherein the movement plane of the transfer device is essentially parallel to at least one sample transport plane of the sample transport device.

15. A method for transferring sample containers in a sample handling system, the method comprising:
i) providing at least one transfer device according to claim 1 referring to a transfer device;
ii) transferring the sample containers in the sample handling system by moving the at least one moving unit in the at least one movement plane through the array of electromagnetic actuators by magnetic interaction of the at least one permanent magnet with the electromagnetic actuators and positioning the sample containers by using the at least one gripper unit.
